(19) United States
(12) Patent Application Publication
(10) Pub. No.: US 2026/0326525 A1
(43) Pub. Date: Oct. 22, 2026

(54) VEHICULAR DRIVE DEVICE

(71) Applicant: AISIN CORPORATION, Kariya (JP)

(72) Inventors: Nakatsune HATTORI, Kariya-shi (JP); Rei KITAGAWA, Kariya-shi (JP)

(73) Assignee: AISIN CORPORATION, Kariya (JP)

(21) Appl. No.: 19/576,860

(22) Filed: Mar. 24, 2026

(30) Foreign Application Priority Data
Mar. 28, 2025 (JP) 2025-055307

(51) Int. Cl. B60K 1/00; B60K 17/16

(52) U.S. Cl. CPC B60K 1/00; B60K 17/16; B60K 2001/001

(57) ABSTRACT

A vehicular drive device according to the present disclosure includes a rotating electrical machine including a rotor, a transmission that changes speed of rotation of the rotor, and a differential gear mechanism that includes a differential input gear, and distributes rotation transmitted from the transmission to the differential input gear to output members drivingly coupled to a pair of wheels, in which the rotor and the differential gear mechanism are coaxially disposed, the transmission includes a first counter gear mechanism and a second counter gear mechanism that are disposed on axes different from an axis of the rotor and the differential gear mechanism, and an engagement device, the first counter gear mechanism includes a first gear that rotates in conjunction with the rotor, a second gear, and a third gear that meshes with the differential input gear, the second counter gear mechanism includes a fourth gear that rotates in conjunction with the second gear, and a fifth gear that meshes with the differential input gear, and the engagement device is configured such that a state of the engagement device is changeable between a first state in which the first gear and the second gear are integrally rotated, and a second state in which the first gear and the third gear are integrally rotated.

### CROSS REFERENCE TO RELATED APPLICATIONS

This application is based on and claims priority under 35 U.S.C. § 119 to Japanese Patent Application No. 2025-055307, filed on Mar. 28, 2025, the entire content of which is incorporated herein by reference.

### TECHNICAL FIELD

The present disclosure relates to a vehicular drive device.

### BACKGROUND DISCUSSION

A vehicular drive device including a rotating electrical machine having a rotor, a pair of output members, a transmission, and a differential gear mechanism having a differential input gear is used. An example of such a vehicular drive device is disclosed in JP 2022-152823 A. In the vehicular drive device (vehicular drive device 100) disclosed in JP 2022-152823 A, a rotor (rotor 2B) and a differential gear mechanism (differential gear mechanism 3) are coaxially disposed, and a transmission (transmission mechanism 1) includes a counter gear mechanism (first gear 12, second gear 14, third gear 22, fourth gear 24) and an engagement device (meshing engagement device 30).

In the vehicular drive device disclosed in JP 2022-152823 A, the transmission is provided with two gear pairs (a first gear 12, a third gear 22, a second gear 14, and a fourth gear 24) having different gear ratios, and driving force transmission path is switched by the engagement device, by which two-speed shifting can be performed.

However, in the vehicular drive device disclosed in JP 2022-152823 A, the two gear pairs are provided on the same two axes, and thus there has been a problem that it is difficult to make a difference in gear ratio due to constraints on strength, or the like.

A need thus exists for a vehicular drive device which is not susceptible to the drawback mentioned above.

### SUMMARY

A vehicular drive device according to the present disclosure includes
a rotating electrical machine including a rotor,
a transmission that changes speed of rotation of the rotor, and
a differential gear mechanism that includes a differential input gear, and distributes rotation transmitted from the transmission to the differential input gear to output members drivingly coupled to a pair of wheels, in which
the rotor and the differential gear mechanism are coaxially disposed,
the transmission includes a first counter gear mechanism and a second counter gear mechanism that are disposed on axes different from an axis of the rotor and the differential gear mechanism, and an engagement device,
the first counter gear mechanism includes a first gear that rotates in conjunction with the rotor, a second gear, and a third gear that meshes with the differential input gear,
the second counter gear mechanism includes a fourth gear that rotates in conjunction with the second gear, and a fifth gear that meshes with the differential input gear, and
the engagement device is configured such that a state of the engagement device is changeable between a first state in which the first gear and the second gear are integrally rotated, and a second state in which the first gear and the third gear are integrally rotated.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of a vehicular drive device according to an embodiment;

FIG. 2 is a partially enlarged view of FIG. 1;

FIG. 3 is a schematic layout diagram as viewed in an axial direction;

FIG. 4 is a cross-sectional view showing a structure in a case;

FIG. 5 is a schematic diagram showing a power transmission path of a first speed;

FIG. 6 is a schematic diagram showing a power transmission path of a second speed;

FIG. 7 is a schematic diagram of a vehicular drive device according to another aspect;

FIG. 8 is a schematic diagram of a vehicular drive device according to another aspect;

FIG. 9 is a schematic diagram of a vehicular drive device according to another aspect; and

FIG. 10 is a schematic diagram of a vehicular drive device according to another aspect.

### DETAILED DESCRIPTION

An embodiment of a vehicular drive device will be described with reference to the drawings. A vehicular drive device 1 of the present embodiment is used by being mounted in a battery electric vehicle (BEV) that travels with power stored in an energy storage device such as a battery or capacitor.

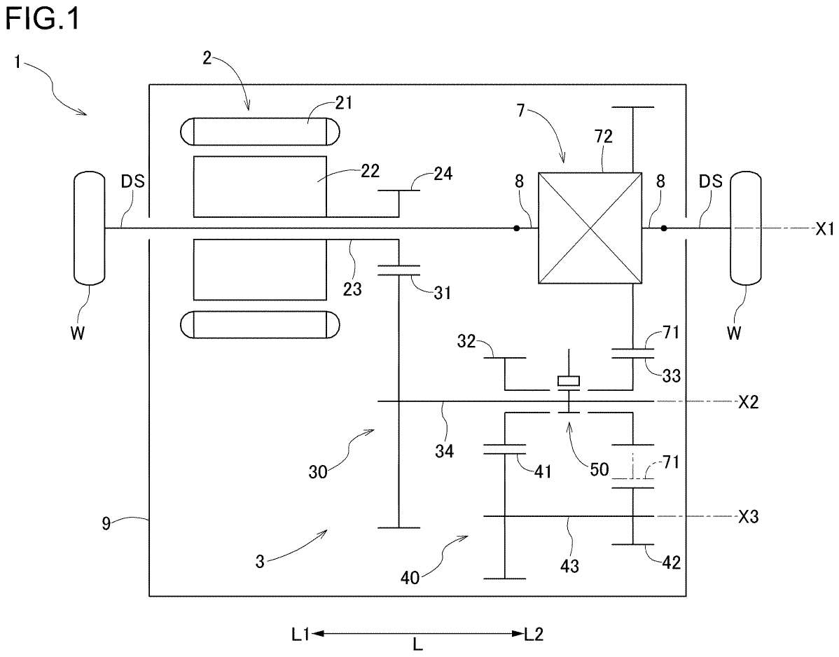

As shown in FIG. 1, the vehicular drive device 1 includes a rotating electrical machine 2, a transmission 3, a differential gear mechanism 7, and output members 8 drivingly coupled to wheels W. In a power transmission path between the rotating electrical machine 2 and the wheels W, the rotating electrical machine 2, the transmission 3, the differential gear mechanism 7, and the output members 8 are provided in the order as described. In the present embodiment, the transmission 3 includes a first counter gear mechanism 30, a second counter gear mechanism 40, and an engagement device 50. In addition, the vehicular drive device 1 includes a case 9 that houses the rotating electrical machine 2, the transmission 3 (the first counter gear mechanism 30, the second counter gear mechanism 40, and the engagement device 50), the differential gear mechanism 7, and the output members 8.

In the present embodiment, the “drivingly coupled” means a state in which two rotational elements are coupled so as to be able to transmit driving force. This concept includes a state in which two rotational elements are coupled so as to rotate integrally and a state in which two rotational elements are coupled so as to be able to transmit driving force via one or more transmission members. Such a transmission member may include various members (a shaft, a gear mechanism, a belt, a chain, and the like) that transmit rotation with or without speed change, and may include an engagement device (a friction engagement device, a meshing engagement device, or the like) that selectively transmits rotation and driving force.

The “rotating electrical machine” is used as a concept including any of a motor (electric motor), a generator, and a motor-generator that functions as both the motor and the generator as necessary.

The rotating electrical machine 2 is disposed on a first axis X1. The differential gear mechanism 7 is disposed on a first axis X1, coaxial with the rotating electrical machine 2. The first counter gear mechanism 30 is disposed on a second axis X2 different from the first axis X1. In the present embodiment, the engagement device 50 is disposed on the second axis X2, coaxial with the first counter gear mechanism 30. The second counter gear mechanism 40 is disposed on a third axis X3 different from the first axis X1 and the second axis X2.

The first axis X1, the second axis X2, and the third axis X3 are parallel to each other, and in the present embodiment, a direction parallel to these axes is referred to as an “axial direction L”. One side in the axial direction L (in this example, a side on which the rotating electrical machine 2 is disposed with respect to the differential gear mechanism 7) is referred to as a “first axial side L1”, and another side in the axial direction L (a side on which the differential gear mechanism 7 is disposed with respect to the rotating electrical machine 2), which is the opposite side of the “first axial side L1”, is referred to as a “second axial side L2”.

The rotating electrical machine 2 functions as a driving force source for the wheels W. The rotating electrical machine 2 includes a stator 21 fixed to the case 9 which is a non-rotary member, and a rotor 22 rotatably supported radially inside the stator 21. The rotor 22 is coupled to a rotor shaft 23 so as to rotate integrally. The rotor shaft 23 is formed as a hollow shaft, and one of a pair of drive shafts DS is disposed radially inside the rotor shaft 23.

A rotor output gear 24 is provided on an outer surface of a portion of the rotor shaft 23, the portion extending on the second axial side L2 with respect to the rotor 22. The rotor output gear 24 is a gear that rotates integrally with the rotor 22 via the rotor shaft 23, and in the present embodiment, the rotor output gear 24 corresponds to a “drive gear”. In the present embodiment, the rotor output gear 24 as the “drive gear” meshes with a first counter input gear 31 of the first counter gear mechanism 30 that constitutes the transmission 3.

The transmission 3 changes speed of rotation of the rotor 22. The transmission 3 changes the speed of rotation of the rotor 22 and transmits the rotation to the differential gear mechanism 7. Typically, the transmission 3 reduces speed of the rotation of the rotor 22, amplifies the driving force accordingly, and transmits the amplified driving force to the differential gear mechanism 7. The transmission 3 includes the first counter gear mechanism 30, the second counter gear mechanism 40, and the engagement device 50. In the present embodiment, the engagement device 50 is provided in a state of being incorporated in the first counter gear mechanism 30 and combined with the first counter gear mechanism 30.

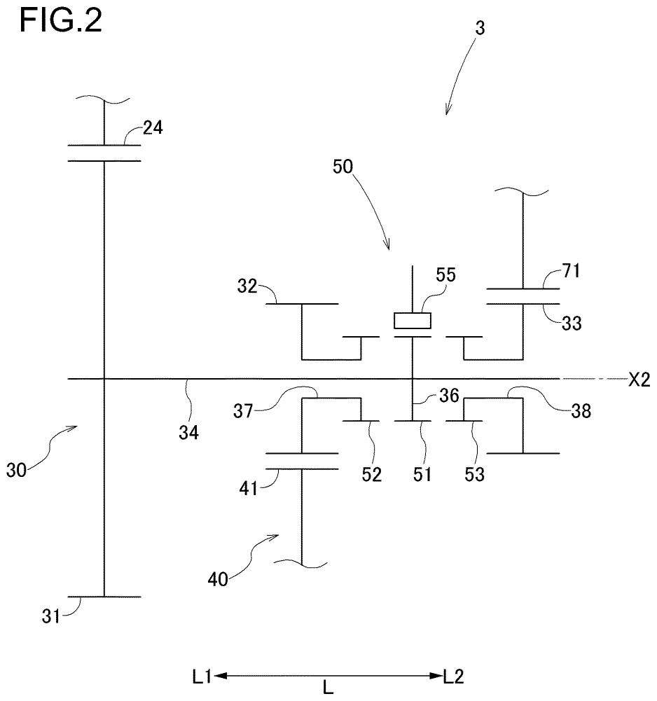

As shown in FIGS. 1 and 2, the first counter gear mechanism 30 includes a first counter input gear 31, a first counter first output gear 32, a first counter second output gear 33, and a first counter shaft 34. The first counter input gear 31 meshes with the rotor output gear 24. The first counter input gear 31 rotates in conjunction with the rotor 22 by meshing with the rotor output gear 24 that rotates integrally with the rotor 22. The first counter shaft 34 is integrated with the first counter input gear 31, and is disposed to extend from the first counter input gear 31 to the second axial side L2.

The first counter first output gear 32 is formed on an outer surface of a first forming member 37 that is hollow and fitted on the first counter shaft 34. The first counter second output gear 33 is formed on an outer surface of a second forming member 38 that is hollow and fitted on the first counter shaft 34. In the present embodiment, the first counter second output gear 33 is disposed on the second axial side L2 with respect to the first counter first output gear 32.

In the present embodiment, an integrally formed part 36 having a flange shape, formed integrally with the first counter shaft 34, and extending in a radial direction is provided at a predetermined position in the axial direction L on the first counter shaft 34. The first forming member 37 is disposed at a position adjacent to the first axial side L1 of the integrally formed part 36, and the second forming member 38 is disposed at a position adjacent to the second axial side L2 of the integrally formed part 36. The first counter first output gear 32 formed on the outer surface of the first forming member 37 meshes with a second counter input gear 41 of the second counter gear mechanism 40. The first counter second output gear 33 formed on the outer surface of the second forming member 38 meshes with a differential input gear 71 of the differential gear mechanism 7.

In the present embodiment, the first counter input gear 31 corresponds to a “first gear”, the first counter first output gear 32 corresponds to a “second gear”, and the first counter second output gear 33 corresponds to a “third gear”.

In the present embodiment, both the number of teeth of the first counter first output gear 32 and the number of teeth of the first counter second output gear 33 are set to be smaller than the number of teeth of the first counter input gear 31. The number of teeth of the first counter first output gear 32 and the number of teeth of the first counter second output gear 33 are set to be equal to each other.

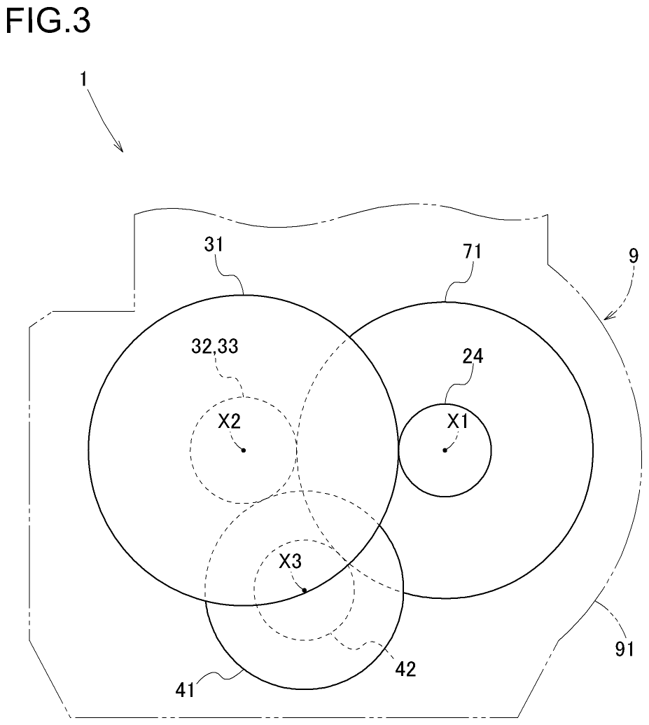

As shown in FIG. 1, the second counter gear mechanism 40 includes the second counter input gear 41, a second counter output gear 42, and a second counter shaft 43 integrally coupling these gears. The second counter input gear 41 meshes with the first counter first output gear 32. The second counter input gear 41 rotates in conjunction with the first counter first output gear 32 by meshing with the first counter first output gear 32. The second counter output gear 42 meshes with the differential input gear 71 of the differential gear mechanism 7. As shown in FIG. 3, the second counter output gear 42 meshes with the differential input gear 71 at a circumferential position different from that of the first counter second output gear 33.

In the present embodiment, the second counter input gear 41 corresponds to a “fourth gear”, and the second counter output gear 42 corresponds to a “fifth gear”.

In the present embodiment, the second counter output gear 42 is disposed on the second axial side L2 with respect to the second counter input gear 41. The number of teeth of the second counter output gear 42 is set to be smaller than the number of teeth of the second counter input gear 41.

As shown in FIG. 2, the engagement device 50 includes a first engagement portion 51, a second engagement portion 52, a third engagement portion 53, and an engagement sleeve 55. The first engagement portion 51, the second engagement portion 52, and the third engagement portion 53 are arranged side by side in the axial direction L at the same radial position with respect to the second axis X2. The engagement sleeve 55 is slidably provided in the axial direction L, and is able to be commonly engaged with the first engagement portion 51, the second engagement portion 52, and the third engagement portion 53.

The first engagement portion 51 is formed on an outer surface of the integrally formed part 36 integrally formed with the first counter shaft 34. The second engagement portion 52 is formed on an outer surface of an end on the second axial side L2 of the first forming member 37 on which the first counter first output gear 32 is formed. The third engagement portion 53 is formed on an outer surface of an end on the first axial side L1 of the second forming member 38 on which the first counter second output gear 33 is formed. The second engagement portion 52, the first engagement portion 51, and the third engagement portion 53 are arranged in the described order from the first axial side L1 toward the second axial side L2.

The engagement sleeve 55 is disposed radially outside the first engagement portion 51, the second engagement portion 52, and the third engagement portion 53 so as to surround them. The first engagement portion 51, the second engagement portion 52, the third engagement portion 53, and the engagement sleeve 55 each have, for example, a spline groove, and are engaged with each other in a state in which the engagement sleeve 55 is slidable in the axial direction L. The engagement sleeve 55 is driven by an actuator such as a solenoid or an electric motor, for example, and is slidable in the axial direction L.

When the engagement sleeve 55 moves to the first axial side L1 and engages with both the first engagement portion 51 and the second engagement portion 52, the first counter shaft 34 and the first forming member 37 are brought into a state of integral rotation via these portions. As a result, the first counter input gear 31 that rotates integrally with the first counter shaft 34 and the first counter first output gear 32 formed on the first forming member 37 are brought into a state of integral rotation. Thus, by the engagement sleeve 55 being moved to the first axial side L1, the engagement device 50 may be brought into a state (hereinafter, referred to as a “first state”) in which the first counter input gear 31 and the first counter first output gear 32 are integrally rotated.

In the first state, the engagement sleeve 55 is not engaged with the third engagement portion 53, and the first counter input gear 31 and the first counter second output gear 33 are relatively rotatable. Therefore, in the first state, transmission of the driving force between the first counter input gear 31 and the first counter second output gear 33 is interrupted.

When the engagement sleeve 55 moves to the second axial side L2 and engages with both the first engagement portion 51 and the third engagement portion 53, the first counter shaft 34 and the second forming member 38 are brought into a state of integral rotation via these portions. As a result, the first counter input gear 31 that rotates integrally with the first counter shaft 34 and the first counter second output gear 33 formed on the second forming member 38 are brought into a state of integral rotation. Thus, by the engagement sleeve 55 being moved to the second axial side L2, the engagement device 50 may be brought into a state (hereinafter, referred to as a “second state”) in which the first counter input gear 31 and the first counter second output gear 33 are integrally rotated.

In the second state, the engagement sleeve 55 is not engaged with the second engagement portion 52, and the first counter input gear 31 and the first counter first output gear 32 are relatively rotatable. Therefore, in the second state, transmission of the driving force between the first counter input gear 31 and the first counter first output gear 32 is interrupted.

In a transition process between the first state and the second state, if the engagement sleeve 55 engages not with the second engagement portion 52 and the third engagement portion 53 but with the first engagement portion 51 alone, both the first forming member 37 and the second forming member 38 are brought into a state of rotation relative to the first counter shaft 34. As a result, the first counter input gear 31 that rotates integrally with the first counter shaft 34, the first counter first output gear 32 formed on the first forming member 37, and the first counter second output gear 33 formed on the second forming member 38 are brought into a state of rotation relative to each other. Thus, the engagement device 50 may be in a state (hereinafter, referred to as a “third state”) in which the first counter input gear 31 and both the first counter first output gear 32 and the first counter second output gear 33 are relatively rotatable.

In this manner, the engagement device 50 is configured such that a state thereof is changeable between the first state and the second state, and is further changeable to the third state, according to a position of the engagement sleeve 55 in the axial direction L. The transmission 3 is able to form two shift speeds and is further able to form a neutral according to a state of the engagement device 50. This point will be described later.

The differential gear mechanism 7 distributes the rotation transmitted from the transmission 3 to a pair of output members 8. The differential gear mechanism 7 includes a differential input gear 71 and a differential main body 72. The differential input gear 71 functions as an input unit of the differential gear mechanism 7. As shown in FIGS. 1 and 3, each of the first counter second output gear 33 of the first counter gear mechanism 30 and the second counter output gear 42 of the second counter gear mechanism 40 meshes with the differential input gear 71 from radially outside. The first counter second output gear 33 and the second counter output gear 42 mesh with the differential input gear 71 at positions different from each other in the circumferential direction.

The differential main body 72 functions as a core component of the differential gear mechanism 7. The differential main body 72 includes a hollow case that rotates integrally with the differential input gear 71, a plurality of pinion gears rotatably supported by the hollow case, and a pair of side gears that meshes with the plurality of pinion gears and rotates integrally with the output members 8. The differential main body 72 distributes the rotation of the differential input gear 71 to the pair of output members 8.

The output members 8 are drivingly coupled to the wheels W. The pair of output members 8 is drivingly coupled, one to each wheel W. The pair of output members 8 is drivingly coupled to the wheels W via the respective drive shafts DS.

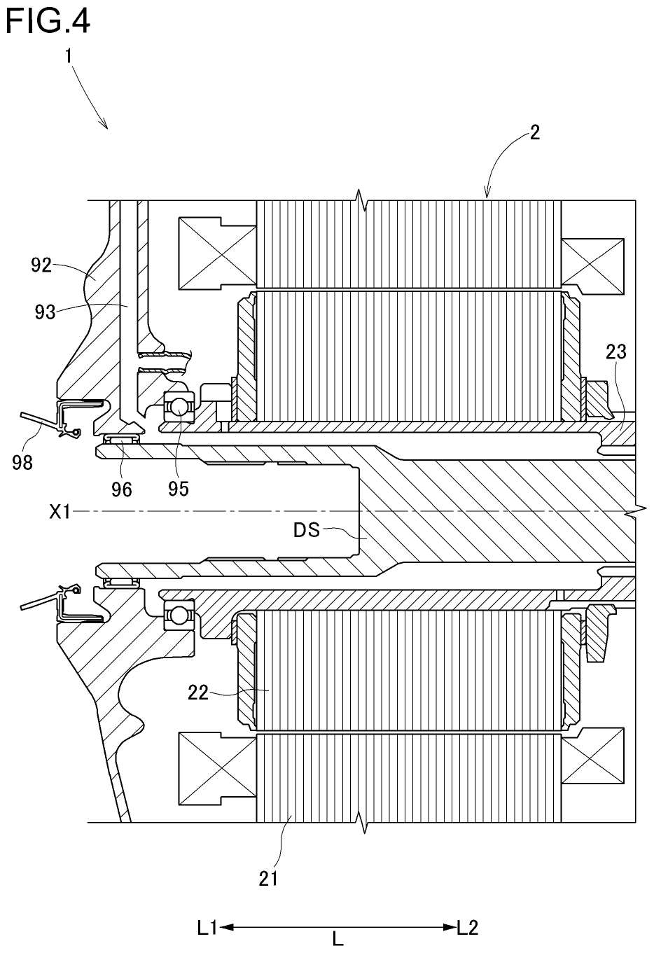

The case 9 has a peripheral wall 91 (see FIG. 3) that houses the rotating electrical machine 2, the transmission 3, the differential gear mechanism 7, and the like. As shown in FIG. 4, the case 9 includes a first end wall 92 that covers the opening on the first axial side L1 of the peripheral wall 91, and a second end wall that covers an opening on the second axial side L2 of the peripheral wall 91. The case 9 further includes a partition wall that partitions, in the axial direction L, a housing space for the rotating electrical machine 2 and a housing space for the transmission 3 and the differential gear mechanism 7, and another wall.

The rotor shaft 23 and a drive shaft DS are rotatably supported by the first end wall 92. In the present embodiment, the rotor shaft 23 is rotatably supported on an inner peripheral surface of a through hole formed in the first end wall 92, via a first bearing 95. In the present embodiment, a ball bearing is used as the first bearing 95. The drive shaft DS is rotatably supported on the inner peripheral surface of the through hole formed in the first end wall 92, via a second bearing 96. In the present embodiment, as the second bearing 96, a needle roller bearing having a diameter smaller than that of the first bearing 95 is used. The second bearing 96 is disposed radially inside the first bearing 95 at a position on the first axial side L1 with respect to the first bearing 95.

An oil passage 93 for supplying oil for cooling the rotor 22 and lubricating the first bearing 95 and the second bearing 96 is formed inside the first end wall 92. The oil passage 93 is formed inside the first end wall 92, extending in the radial direction. In the present embodiment, the oil passage 93 and the second bearing 96 have portions overlapping each other as viewed in the radial direction with reference to the first axis X1. In the present embodiment, the second bearing 96 is disposed such that about a half thereof on the second axial side L2 overlaps an area of the oil passage 93 in the same axial direction L.

In the present embodiment, with respect to arrangement of two members, “to have portions overlapping each other” means that, in a case where a virtual straight line parallel to the direction of a line of sight is moved in each direction orthogonal to the virtual straight line, a region where the virtual straight line intersects both of the two members exists in at least a part.

In the present embodiment, a seal member 98 is also provided on an inner peripheral surface of a penetrating portion formed in the first end wall 92. The seal member 98 plays a role of blocking the oil supplied from the oil passage 93 and holding the oil on the second axial side L2 with respect to the oil passage 93. The seal member 98 is disposed on the first axial side L1 with respect to the second bearing 96. The seal member 98 has a portion overlapping with the first bearing 95 as viewed in an axial direction. The seal member 98 also has a portion overlapping with the second bearing 96 as viewed in the axial direction. The seal member 98 does not overlap with the second bearing 96 as viewed in the radial direction, but is disposed adjacent to the first axial side L1 of the second bearing 96.

By configuring an arrangement relationship of the oil passage 93, the second bearing 96, and the seal member 98 as described above, an increase in a width dimension (dimension in a direction orthogonal to the axial direction L) of the vehicular drive device 1 can be avoided or minimized.

As described above, the engagement device 50 is configured such that the state thereof is changeable between the first state in which the first counter input gear 31 and the first counter first output gear 32 are integrally rotated, and the second state in which the first counter input gear 31 and the first counter second output gear 33 are integrally rotated. The engagement device 50 is configured such that the state thereof is further changeable to the third state in which the first counter input gear 31 and both the first counter first output gear 32 and the first counter second output gear 33 are relatively rotatable. The transmission 3 is able to form the first speed, the second speed, and the neutral according to the state of the engagement device 50.

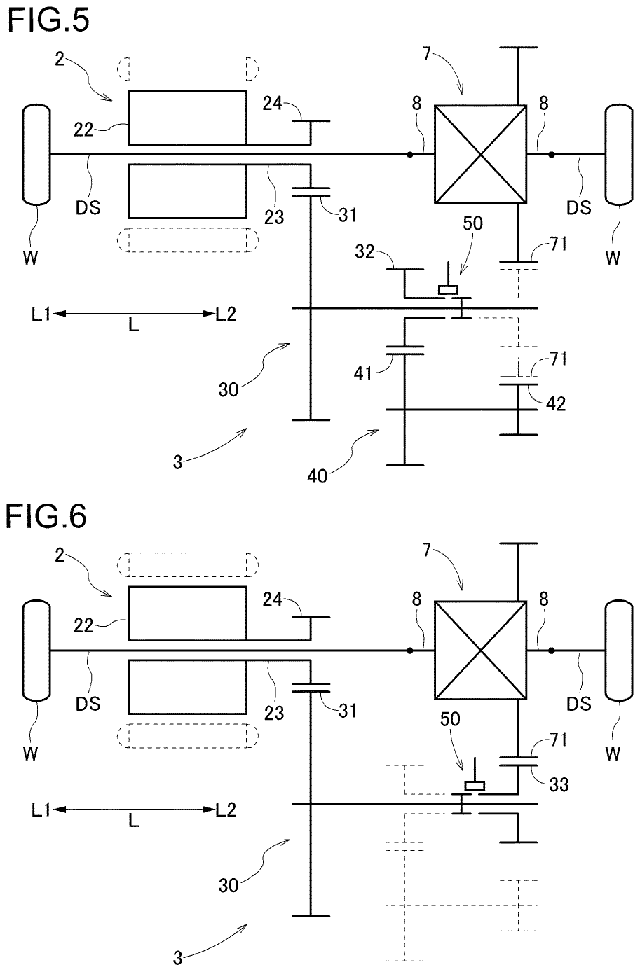

As shown in FIG. 5, the first speed is formed by engaging the engagement sleeve 55 with both the first engagement portion 51 and the second engagement portion 52 to bring the engagement device 50 into the first state. In the first state of the engagement device 50, the first counter input gear 31 and the first counter first output gear 32 rotate integrally, and the first counter input gear 31 and the first counter second output gear 33 rotate relative to each other. Therefore, in the first state of the engagement device 50, the first counter gear mechanism 30 and the second counter gear mechanism 40 are drivingly coupled, and the rotation of the rotor 22 is transmitted to the differential gear mechanism 7 via the first counter gear mechanism 30 and the second counter gear mechanism 40.

At the first speed, rotation of the rotor output gear 24 is transmitted to the differential input gear 71 through a first shift by the first counter gear mechanism 30 and a second shift by the second counter gear mechanism 40. In the present embodiment, the rotation of the rotor output gear 24 is transmitted to the differential input gear 71 through first speed reduction based on a gear ratio between the first counter input gear 31 and the first counter first output gear 32, and second speed reduction based on a gear ratio between the second counter input gear 41 and the second counter output gear 42. Thus, at the first speed, a reduction ratio can be set large by interposing the second counter gear mechanism 40 between the first counter gear mechanism 30 and the differential gear mechanism 7. In the present embodiment, the first speed is a low speed having a larger reduction ratio than the second speed.

As shown in FIG. 6, the second speed is formed by engaging the engagement sleeve 55 with both the first engagement portion 51 and the third engagement portion 53 to bring the engagement device 50 into the second state. In the second state of the engagement device 50, the first counter input gear 31 and the first counter second output gear 33 rotate integrally, and the first counter input gear 31 and the first counter first output gear 32 rotate relative to each other. Therefore, in the second state of the engagement device 50, the first counter gear mechanism 30 and the differential gear mechanism 7 are drivingly coupled, and the rotation of the rotor 22 is transmitted to the differential gear mechanism 7 not via the second counter gear mechanism 40, but via the first counter gear mechanism 30 alone.

At the second speed, the rotation of the rotor output gear 24 is transmitted to the differential input gear 71 through shifting by the first counter gear mechanism 30. In the present embodiment, the rotation of the rotor output gear 24 is transmitted to the differential input gear 71 through speed reduction based on a gear ratio between the first counter input gear 31 and the first counter second output gear 33. Thus, because the first counter gear mechanism 30 and the differential gear mechanism 7 are directly drivingly coupled to each other without the second counter gear mechanism 40 interposed therebetween, the second speed is a high speed having a smaller reduction ratio than the first speed.

At the second speed, because the second counter gear mechanism 40 is not interposed in the power transmission path, energy loss can be kept low. It may also be advantageous for a vehicle in which the vehicular drive device 1 is mounted that energy loss at the second speed, which is considered to be formed in many cases at a time of high-speed traveling, can be kept low.

The neutral is formed by engaging the engagement sleeve 55 with the first engagement portion 51 alone to bring the engagement device 50 into the third state. In the third state of the engagement device 50, the first counter input gear 31 and the first counter first output gear 32 rotate relative to each other, and the first counter input gear 31 and the first counter second output gear 33 also rotate relative to each other. Therefore, in the third state of the engagement device 50, the transmission of the driving force between the transmission 3 and the differential gear mechanism 7 is interrupted, the rotation of the rotor 22 is not transmitted to the differential gear mechanism 7, and the rotation of the differential input gear 71 is not transmitted to the rotor 22.

At the neutral, a rotational speed of the rotor 22 can be adjusted in a state in which the differential input gear 71 that rotates in conjunction with the wheels W and the rotor 22 are separated. By changing the rotational speed of the rotor 22 so that a state in which the first engagement portion 51 synchronously rotates with either the second engagement portion 52 or the third engagement portion 53 is switched to a state in which the first engagement portion 51 synchronously rotates with the other, switching between the first speed and the second speed during forward travel (for example, during coasting or traveling by a driving force source different from the rotating electrical machine 2) can be appropriately performed. In particular, even when a rotation direction of the rotor 22 is reversed between the first speed and the second speed as in the present embodiment, and a rotational speed range of the rotor 22 is wide, switching between the first speed and the second speed can be appropriately performed.

In the present embodiment, both the first counter second output gear 33 of the first counter gear mechanism 30 and the second counter output gear 42 of the second counter gear mechanism 40 are configured to mesh with the differential input gear 71. Therefore, as compared with a configuration in which the transmission 3 includes, for example, two gear pairs on two axes, the number of gears required in addition to the engagement device 50 to implement a shifting function can be reduced. Therefore, there is also an advantage that a two-speed shifting function can be implemented while keeping costs low. Thus, in the present embodiment, it is possible to provide the vehicular drive device 1 for which the gear ratio can be set easily and flexibly at low costs.

### Other Embodiments

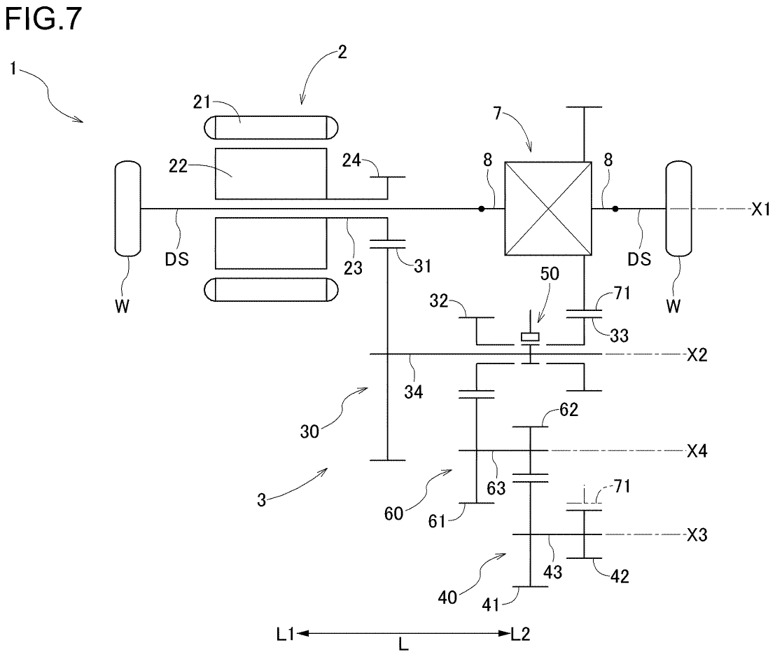

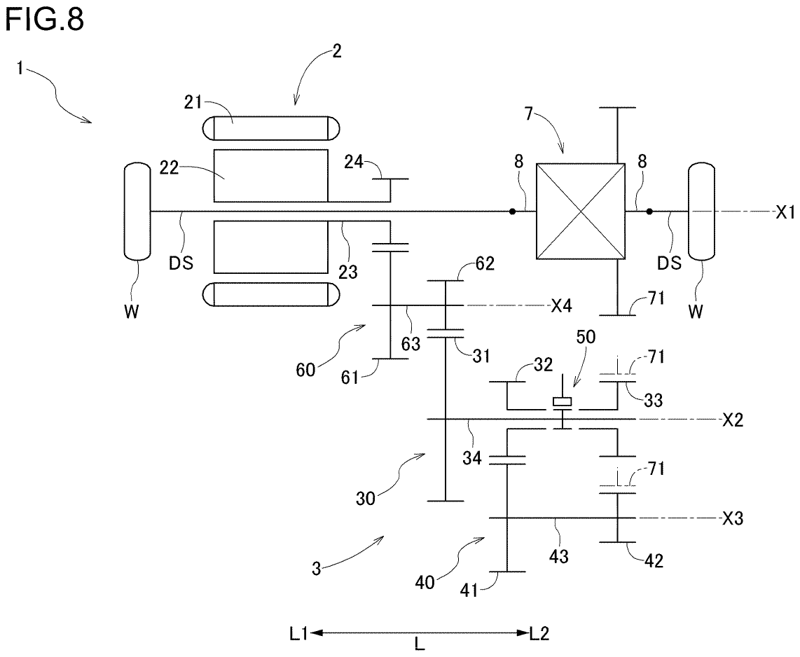

(1) In the above embodiment, a configuration in which the transmission 3 includes the first counter gear mechanism 30, the second counter gear mechanism 40, and the engagement device 50 alone has been described as an example. However, the present disclosure is not limited to such a configuration. For example, as shown in FIGS. 7 and 8, the transmission 3 may further include a third counter gear mechanism 60 in addition to the first counter gear mechanism 30, the second counter gear mechanism 40, and the engagement device 50. In these examples, the third counter gear mechanism 60 is disposed on a fourth axis X4 different from the first axis X1, the second axis X2, and the third axis X3. The third counter gear mechanism 60 includes a third counter input gear 61, a third counter output gear 62, and a third counter shaft 63 integrally coupling these gears. In the example in FIG. 7, the third counter gear mechanism 60 is interposed between the first counter gear mechanism 30 and the second counter gear mechanism 40. The third counter input gear 61 meshes with the first counter first output gear 32. The third counter output gear 62 meshes with the second counter input gear 41. In such a configuration, the second counter input gear 41 rotates in conjunction with the first counter first output gear 32 via the third counter gear mechanism 60.

In the present embodiment, when a certain gear (target gear) “rotates in conjunction” with another gear (mating gear), this means that the target gear rotates at a rotational speed proportional to a rotational speed of the mating gear.

(2) In the example in FIG. 8, the third counter gear mechanism 60 is interposed between the rotor 22 and the first counter gear mechanism 30. The third counter input gear 61 meshes with the rotor output gear 24. The third counter output gear 62 meshes with the first counter input gear 31. In such a configuration, the first counter input gear 31 rotates in conjunction with the rotor output gear 24 via the third counter gear mechanism 60.

(3) Alternatively, the transmission 3 may further include a third counter gear mechanism, a fourth counter gear mechanism, . . . in addition to the first counter gear mechanism 30, the second counter gear mechanism 40, and the engagement device 50. The additionally provided third counter gear mechanism, fourth counter gear mechanism, . . . may be interposed collectively between the rotor 22 and the first counter gear mechanism 30, or may be interposed collectively between the first counter gear mechanism 30 and the second counter gear mechanism 40. Alternatively, the additionally provided third counter gear mechanism, fourth counter gear mechanism, . . . may be appropriately distributed and interposed between the rotor 22 and the first counter gear mechanism 30 and between the first counter gear mechanism 30 and the second counter gear mechanism 40.

(4) In the above embodiment, a configuration in which the engagement device 50 is a meshing engagement device has been described as an example. However, the present disclosure is not limited to such a configuration, and the engagement device 50 may be, for example, a friction engagement device.

(5) In the above embodiment, a configuration in which the transmission 3 can implement the two-speed shifting has been described as an example. However, the present disclosure is not limited to such a configuration. For example, the transmission 3 may be configured such that three-or-more speed shifting can be implemented.

(6) In the above embodiment, the description has been given mainly assuming that the differential gear mechanism 7 is of a bevel-gear type. However, the present disclosure is not limited to such a configuration, and the differential gear mechanism 7 may be, for example, a planetary-gear type.

(7) In the above embodiment, the output members 8 may be any members as long as the output members 8 are interposed between the respective side gears of the differential gear mechanism 7 and drive shafts DS. The output members 8 may be formed integrally with the respective side gears or the respective drive shafts DS, or may be formed as separate members from the side gears or the drive shafts DS.

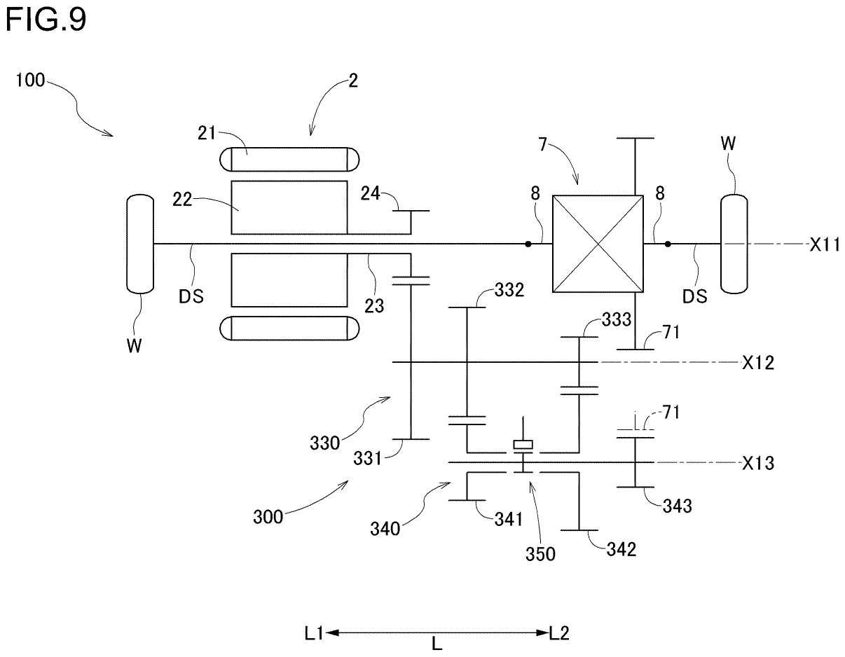

(8) In the above embodiment, a configuration in which both the first counter second output gear 33 of the first counter gear mechanism 30 and the second counter output gear 42 of the second counter gear mechanism 40 mesh with the differential input gear 71 has been described as an example. However, a configuration in which the number of gears meshing with the differential input gear 71 is limited to one is also disclosed herein. An example of such a configuration is shown in FIG. 9. In FIG. 9, the similar members to those in the above embodiment are denoted by the same reference signs.

A vehicular drive device 100 shown in FIG. 9 includes a rotating electrical machine 2, a transmission 300, a differential gear mechanism 7, and output members 8. The transmission 300 includes a first counter gear mechanism 330, a second counter gear mechanism 340, and an engagement device 350. The rotating electrical machine 2, the differential gear mechanism 7, and the output members 8 are disposed on a first axis X11. The first counter gear mechanism 330 is disposed on a second axis X12. The second counter gear mechanism 340 and the engagement device 350 are disposed on a third axis X13. The first counter gear mechanism 330 includes a first counter input gear 331, a first counter first output gear 332, and a first counter second output gear 333. The second counter gear mechanism 340 includes a second counter first input gear 341, a second counter second input gear 342, and a second counter output gear 343. The first counter input gear 331 meshes with the rotor output gear 24. The first counter first output gear 332 meshes with the second counter first input gear 341. The first counter second output gear 333 meshes with the second counter second input gear 342. The second counter output gear 343 meshes with a differential input gear 71. The engagement device 350 is configured such that a state thereof is changeable between a state in which the second counter first input gear 341 and the second counter output gear 343 are integrally rotated, and a state in which the second counter second input gear 342 and the second counter output gear 343 are integrally rotated. That is, the vehicular drive device 100 having the following configurations is also disclosed herein.

A vehicular drive device 100 including
a rotating electrical machine 2 including a rotor 22,
a pair of output members 8 drivingly coupled to wheels W,
a transmission 300 that changes speed of rotation of the rotor 22, and
a differential gear mechanism 7 that includes a differential input gear 71, and distributes rotation transmitted from the transmission 300 to the differential input gear 71 to a pair of output members 8, in which
the rotor 22 and the differential gear mechanism 7 are coaxially disposed,
the transmission 300 includes a first counter gear mechanism 330 and a second counter gear mechanism 340 that are disposed on axes different from an axis of the rotor 22 and the differential gear mechanism 7, and an engagement device 350,
the first counter gear mechanism 330 includes a first counter input gear 331 (an example of a “1A gear”) that rotates in conjunction with the rotor 22, a first counter first output gear 332 (an example of a “2A gear”), and a first counter second output gear 333 (an example of a “3A gear”),
the second counter gear mechanism 340 includes a second counter first input gear 341 (an example of a “4A gear”) that meshes with the first counter first output gear 332, a second counter second input gear 342 (an example of a “5A gear”) that meshes with the first counter second output gear 333, and a second counter output gear 343 (an example of a “6A gear”) that rotates in conjunction with the differential input gear 71, and
the engagement device 350 is configured such that a state of the engagement device 350 is changeable between a first state in which the second counter first input gear 341 and the second counter output gear 343 are integrally rotated, and a second state in which the second counter second input gear 342 and the second counter output gear 343 are integrally rotated.

In the vehicular drive device 100, the transmission 300 may also include a third counter gear mechanism (further, a fourth counter gear mechanism, . . . ). Structural modification by the transmission 300 further including the third counter gear mechanism (further, the fourth counter gear mechanism, . . . ) can be appropriately performed.

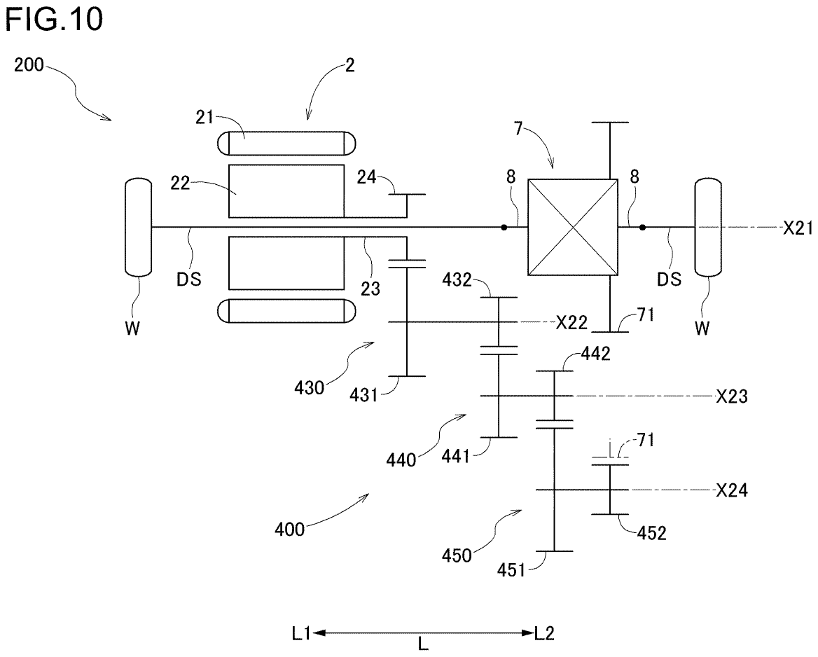

(9) In the above embodiment, a configuration in which the transmission 3 further includes the engagement device 50 in addition to the first counter gear mechanism 30 and the second counter gear mechanism 40 has been described as an example. However, a configuration in which the transmission 3 does not include the engagement device 50 on the premise that the transmission 3 includes a third counter gear mechanism is also disclosed herein. An example of such a configuration is shown in FIG. 10. In FIG. 10, the similar members to those in the above embodiment are denoted by the same reference signs.

A vehicular drive device 200 shown in FIG. 10 includes a rotating electrical machine 2, a transmission 400, a differential gear mechanism 7, and output members 8. The transmission 400 includes a first counter gear mechanism 430, a second counter gear mechanism 440, and a third counter gear mechanism 450. The rotating electrical machine 2, the differential gear mechanism 7, and the output members 8 are disposed on a first axis X21. The first counter gear mechanism 430 is disposed on a second axis X22. The second counter gear mechanism 440 is disposed on a third axis X23. The third counter gear mechanism 450 is disposed on a fourth axis X24. The first counter gear mechanism 430 includes a first counter input gear 431 and a first counter output gear 432. The second counter gear mechanism 440 includes a second counter input gear 441 and a second counter output gear 442. The third counter gear mechanism 450 includes a third counter input gear 451 and a third counter output gear 452. The first counter input gear 431 meshes with a rotor output gear 24. The first counter output gear 432 meshes with the second counter input gear 441. The second counter output gear 442 meshes with the third counter input gear 451. The third counter output gear 452 meshes with a differential input gear 71. That is, the vehicular drive device 200 having the following configurations is also disclosed herein.

A vehicular drive device 200 including
a rotating electrical machine 2 including a rotor 22,
a pair of output members 8 drivingly coupled to wheels W,
a transmission 400 that changes speed of rotation of the rotor 22, and
a differential gear mechanism 7 that includes a differential input gear 71, and
distributes rotation transmitted from the transmission 400 to the differential input gear 71 to a pair of output members 8, in which
the rotor 22 and the differential gear mechanism 7 are coaxially disposed,
the transmission 400 includes a first counter gear mechanism 430, a second counter gear mechanism 440, and a third counter gear mechanism 450 that are disposed on axes different from an axis of the rotor 22 and the differential gear mechanism 7,
the first counter gear mechanism 430 includes a first counter input gear 431 (an example of a “1B gear”) that rotates in conjunction with the rotor 22, and a first counter output gear 432 (an example of a “2B gear”) that rotates integrally with the first counter input gear 431,
the second counter gear mechanism 440 includes a second counter input gear 441 (an example of a “3B gear”) that meshes with the first counter output gear 432, and a second counter output gear 442 (an example of a “4B gear”) that rotates integrally with the second counter input gear 441, and
the third counter gear mechanism 450 includes a third counter input gear 451 (an example of a “5B gear”) that meshes with the second counter output gear 442, and a third counter output gear 452 (an example of a “6B gear”) that rotates integrally with the third counter input gear 451 and rotates in conjunction with the differential input gear 71.

In the vehicular drive device 200, the transmission 400 may also include a fourth counter gear mechanism (further, a fifth counter gear mechanism, . . . ). Structural modification by the transmission 400 further including the fourth counter gear mechanism (further, the fifth counter gear mechanism, . . . ) can be appropriately performed.

(10) Configurations disclosed in each of the embodiments described above (including the above-described embodiment and other embodiments; hereinafter the same) can be applied in combination with a configuration disclosed in another embodiment unless there is a contradiction. For other configurations, the embodiments disclosed herein are examples in all respects, and modifications may be made as appropriate without departing from the scope of the present disclosure.

### Overview of Embodiments

In summary, the vehicular drive device according to the present disclosure preferably has the following configurations.

A vehicular drive device (1) including
a rotating electrical machine (2) including a rotor (22),
a transmission (3) that changes speed of rotation of the rotor (22), and
a differential gear mechanism (7) that includes a differential input gear (71), and distributes rotation transmitted from the transmission (3) to the differential input gear (71) to output members (8) drivingly coupled to a pair of wheels, in which
the rotor (22) and the differential gear mechanism (7) are coaxially disposed,
the transmission (3) includes a first counter gear mechanism (30) and a second counter gear mechanism (40) that are disposed on axes different from an axis of the rotor (22) and the differential gear mechanism (7), and an engagement device (50),
the first counter gear mechanism (30) includes a first gear (31) that rotates in conjunction with the rotor (22), a second gear (32), and a third gear (33) that meshes with the differential input gear (71),
the second counter gear mechanism (40) includes a fourth gear (41) that rotates in conjunction with the second gear (32), and a fifth gear (42) that meshes with the differential input gear (71), and
the engagement device (50) is configured such that a state of the engagement device (50) is changeable between a first state in which the first gear (31) and the second gear (32) are integrally rotated, and a second state in which the first gear (31) and the third gear (33) are integrally rotated.

According to this configuration, a center-to-center distance between the differential input gear (71) and the first counter gear mechanism (30) and a center-to-center distance between the differential input gear (71) and the second counter gear mechanism (40) can be differentiated. Therefore, diameter constraint of each gear can be reduced, and flexibility in gear ratio setting is easily increased. As a result, it is possible to provide the vehicular drive device (1) for which the gear ratio can be set easily and flexibly.

As one aspect,
the rotating electrical machine (2) preferably includes a drive gear (24) that rotates integrally with the rotor (22), and
the drive gear (24) and the first gear (31) preferably mesh with each other, and the second gear (32) and the fourth gear (41) preferably mesh with each other.

According to this configuration, the vehicular drive device (1) for which the gear ratio described above can be set easily and flexibly can be implemented with a relatively small number of components, and costs can be kept low. In addition, because the number of components may be minimized, energy loss in the power transmission path can be kept low.

As one aspect,
the engagement device (50) is preferably configured such that the state of the engagement device (50) is further changeable to a third state in which the first gear (31) and both the second gear (32) and the third gear (33) are relatively rotatable.

According to this configuration, power transmission between the rotating electrical machine (2) and the pair of output members (8) can be interrupted by bringing the engagement device (50) into the third state. Even in a case where the rotational speed of the rotor (22) changes before and after shifting during vehicle traveling, switching between the first state and the second state can be appropriately performed via the third state.

As one aspect,
the third gear (33) and the fifth gear (42) preferably mesh with the differential input gear (71) at positions different from each other in a circumferential direction of the differential input gear (71), from radially outside.

According to this configuration, the third gear (33) of the first counter gear mechanism (30) and the fifth gear (42) of the second counter gear mechanism (40) provided on an axis different from an axis of the first counter gear mechanism (30) can be appropriately meshed with the differential input gear (71). In addition, by appropriately setting the arrangement positions of the first counter gear mechanism (30) and the second counter gear mechanism (40), the vehicular drive device (1) can be downsized as viewed in the axial direction.

The vehicular drive device according to the present disclosure is only required to be able to achieve at least one of the effects described above.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicular drive device comprising:
a rotating electrical machine including a rotor;
a transmission that changes speed of rotation of the rotor; and
a differential gear mechanism that includes a differential input gear, and distributes rotation transmitted from the transmission to the differential input gear to output members drivingly coupled to a pair of wheels, wherein
the rotor and the differential gear mechanism are coaxially disposed,
the transmission includes a first counter gear mechanism and a second counter gear mechanism that are disposed on axes different from an axis of the rotor and the differential gear mechanism, and an engagement device,
the first counter gear mechanism includes a first gear that rotates in conjunction with the rotor, a second gear, and a third gear that meshes with the differential input gear,
the second counter gear mechanism includes a fourth gear that rotates in conjunction with the second gear, and a fifth gear that meshes with the differential input gear, and
the engagement device is configured such that a state of the engagement device is changeable between a first state in which the first gear and the second gear are integrally rotated, and a second state in which the first gear and the third gear are integrally rotated.

2. The vehicular drive device according to claim 1, wherein the rotating electrical machine includes a drive gear that rotates integrally with the rotor, and
the drive gear and the first gear mesh with each other, and the second gear and the fourth gear mesh with each other.

3. The vehicular drive device according to claim 1, wherein the engagement device is configured such that the state of the engagement device is further changeable to a third state in which the first gear and both the second gear and the third gear are relatively rotatable.

4. The vehicular drive device according to claim 2, wherein the engagement device is configured such that the state of the engagement device is further changeable to a third state in which the first gear and both the second gear and the third gear are relatively rotatable.

5. The vehicular drive device according to claim 1, wherein the third gear and the fifth gear mesh with the differential input gear at positions different from each other in a circumferential direction of the differential input gear, from radially outside.

6. The vehicular drive device according to claim 2, wherein the third gear and the fifth gear mesh with the differential input gear at positions different from each other in a circumferential direction of the differential input gear, from radially outside.
